(19) United States
(12) Patent Application Publication
(10) Pub. No.: US 2021/0074161 A1
(43) Pub. Date: Mar. 11, 2021

(54) VEHICLE AND METHOD OF CONTROLLING THE SAME

(71) Applicants: Hyundai Motor Company, Seoul (KR); Kia Motors Corporation, Seoul (KR)

(72) Inventors: Hyungmin KO, Suwon-Si (KR); Jonghyeok PARK, Seosan-Si (KR); Tae Young LEE, Yongin-Si (KR); Yonjun JANG, Changwon-Si (KR); Sungmin JI, lncheon (KR)

(73) Assignees: Hyundai Motor Company, Seoul (KR); Kia Motors Corporation, Seoul (KR)

(21) Appl. No.: 16/739,632

(22) Filed: Jan. 10, 2020

(30) Foreign Application Priority Data
Sep. 6, 2019 (KR) 10-2019-0110562

(51) Int. Cl. G08G 1/16; G08G 1/04; G06K 9/00; B62D 15/02; B60Q 9/00

(52) U.S. Cl. CPC G08G 1/166; G08G 1/04; B60Q 9/008; G06K 9/00798; B62D 15/0265; G08G 1/167

(57) ABSTRACT

A vehicle for preventing a secondary collision during a steering avoidance control, may include a plurality of detection sensors configured to detect a neighboring obstacle in a surrounding of a vehicle, a lane line detector configured to detect a lane line of a travelling lane on which the vehicle is travelling, and a controller configured to determine whether the vehicle departs from the travelling lane on the basis of the detected lane line, determine whether an obstacle is detected in a predetermined area in the travelling lane, determine a risk of collision between the vehicle and the neighboring obstacle, and if the vehicle is predicted to depart from the travelling lane and the vehicle is predicted to collide with the neighboring obstacle, determine whether to perform a steering avoidance control for avoiding the collision on the basis of a result of detecting the obstacle in the predetermined area.

### CROSS-REFERENCE TO RELATED APPLICATION

The present application claims priority to Korean Patent Application No. 10-2019-0110562, filed on Sep. 6, 2019, the entire contents of which is incorporated herein for all purposes by this reference.

### BACKGROUND OF THE INVENTION

### Field of the Invention

The present invention relates to a vehicle and a method of controlling the same, and more specifically, to a vehicle capable of avoiding a secondary collision that may occur during a steering control for preventing a collision with a neighboring vehicle.

### Description of Related Art

A vehicle refers to a device designed to transport people or articles by travelling on a road or railway. Generally, the vehicle may move to various positions using one or more wheels mounted on the vehicle body. Such a vehicle may include a three-wheeled or four-wheeled vehicle, a two-wheeled vehicle, such as a motorcycle, a construction machine, a bicycle, and a train traveling on a railway disposed on a track.

In modern society, vehicles are the most common means of transportation and the number of people using vehicles is increasing. With the development of vehicle technology, easy movement of long distance and convenience are provided, but in places with high population densities, such as Korea, road traffic conditions deteriorate and traffic congestion frequently occurs.

Recently, there have been active studies regarding a vehicle provided with an advanced driver assist system (ADAS), which actively provides information related to the state of a vehicle, the state of a driver, and the surrounding environment to reduce the burden on the driver while enhancing the convenience of the driver.

Examples of the ADAS mounted on a vehicle include a smart cruise control system, a lane keeping assistance system, a lane following assist system, a lane departure warning system, a forward collision-avoidance assist system, a forward collision-avoidance assist-lane-change side (FCA-LS), a forward collision-avoidance assist-lane-change oncoming (FCA-LO), and the like. Such a system is designed to avoid a collision through an emergency braking by determining a risk of collision with an oncoming vehicle or a crossing vehicle in a travelling situation of a vehicle, control a vehicle to travel while keeping an interval with a preceding vehicle, or assist a vehicle in preventing departure from a lane being travelled on.

Among the systems, FCA-LS and FCA-LO are systems that assist a vehicle in preventing a collision when there is a risk of collision with a preceding obstacle at a time of lane change during travelling of the vehicle. However, there is a limitation that such a forward collision avoidance assist system does not consider a risk of secondary collision with another obstacle after avoiding the collision with an obstacle.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a vehicle configured for avoiding a secondary collision with an obstacle which may occur as a result from avoiding a collision with a neighboring obstacle through steering during travelling of the vehicle, and a method of controlling the same.

Additional aspects of the present invention will be set forth in part in the description which follows, and in part, will be obvious from the description, or may be learned by practice of the present invention.

Various aspects of the present invention are directed to providing a vehicle including: a plurality of detection sensors configured to detect a neighboring obstacle in a surrounding of a vehicle; a lane line detector configured to detect a lane line of a travelling lane on which the vehicle is travelling; and a controller configured to determine whether the vehicle departs from the travelling lane on the basis of the detected lane line, determine whether an obstacle is detected in a predetermined area in the travelling lane, determine a risk of collision between the vehicle and the neighboring obstacle, and if the vehicle is predicted to depart from the travelling lane and the vehicle is predicted to collide with the neighboring obstacle, determine whether to perform a steering avoidance control for avoiding the collision on the basis of a result of detecting the obstacle in the predetermined area.

The controller may be configured to control the vehicle to perform the steering avoidance control if an obstacle is not detected in the predetermined area.

The controller may cancel the steering avoidance control and may perform a heading angle alignment steering control such that a travelling direction of the vehicle is parallel to lane lines of the travelling lane if the obstacle is detected in the predetermined area during the steering avoidance control of the vehicle.

The predetermined area may include a side area, a front area, and a rear area of the vehicle in the travelling lane.

The controller may be configured to control the vehicle not to perform the steering avoidance control if the obstacle is detected in the predetermined area.

The controller may be configured to generate a control signal for sending a warning signal if the vehicle is predicted to depart from the travelling lane and the vehicle is predicted to collide with the neighboring obstacle.

The controller may be configured to determine the predetermined area on the basis of a velocity of the vehicle.

The controller may be configured to determine a lateral movement distance for avoiding the collision of the vehicle on the basis of width information related to the lane line of the travelling lane and the vehicle, and may control the vehicle to perform the steering avoidance control on the basis of the determined lateral movement distance.

Various aspects of the present invention are directed to providing a method of controlling a vehicle, the method including: detecting a lane line of a travelling lane on which a vehicle is travelling; determining whether the vehicle departs from the travelling lane on the basis of the detected lane line; determining whether an obstacle is detected in a predetermined area in the travelling lane; determining a risk of collision between the vehicle and a neighboring obstacle in a surrounding of the vehicle; and determining whether to perform a steering avoidance control for avoiding the collision on the basis of a result of detecting the obstacle in the predetermined area if the vehicle is expected to depart from the travelling lane and the vehicle is predicted to collide with the neighboring obstacle.

The determining of whether to perform a steering avoidance control for avoiding the collision may include controlling the vehicle to perform the steering avoidance control if the obstacle is not detected in the predetermined area.

The method may further include cancelling the steering avoidance control and performing a heading angle alignment steering control such that a travelling direction of the vehicle is parallel to lane lines of the travelling lane if the obstacle is detected in the predetermined area during the steering avoidance control of the vehicle.

The predetermined area may include a side area, a front area, and a rear area of the vehicle in the travelling lane.

The determining of whether to perform a steering avoidance control for avoiding the collision may include controlling the vehicle not to perform the steering avoidance control if the obstacle is detected in the predetermined area.

The method may further include generating a control signal for sending a warning signal if the vehicle is predicted to depart from the travelling lane and the vehicle is predicted to collide with the neighboring obstacle.

The method may further include determining the predetermined area on the basis of a velocity of the vehicle.

The controlling of the vehicle to perform the steering avoidance control for avoiding the collision may include: determining a lateral movement distance for returning to the travelling lane of the vehicle on the basis of width information related to lane lines of the travelling lane and the vehicle; and controlling the vehicle to perform the steering avoidance control on the basis of the determined lateral movement distance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a vehicle provided with a plurality of detection sensors and a lane line detector according to an exemplary embodiment of the present invention.

FIG. 2 is a control block diagram illustrating a vehicle according to an exemplary embodiment of the present invention.

FIG. 3 and FIG. 4 are flowcharts showing a method of controlling a vehicle according to an exemplary embodiment of the present invention.

FIG. 5 is a view exemplarily illustrating an avoidable area according to an exemplary embodiment of the present invention.

FIG. 6 is a view exemplarily illustrating a case in which a secondary collision of a vehicle is expected to occur according to an exemplary embodiment of the present invention.

FIG. 7 and FIG. 8 are views illustrating a case in which an obstacle is detected in an avoidable area during a steering control of a vehicle according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like numerals refer to like elements throughout the specification. Not all elements of embodiments of the present invention will be described, and description of what are commonly known in the art or what overlap each other in the exemplary embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in the present specification, specify the presence of stated features, integers, steps, operations, elements, and/or components, but do not preclude the presence or addition of one or more other features, integers, steps, operations, elements, components, and/or groups thereof, unless the context clearly indicates otherwise.

The terms including ordinal numbers like “first” and “second” may be used to explain various components, but the components are not limited by the terms. The terms are only for distinguishing a component from another.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise. Hereinafter, the operating principles and embodiments of the present invention will be described with reference to the accompanying drawings.

Furthermore, the term “obstacle” in the exemplary embodiment of the present invention refers to all objects that have a possibility of colliding with a vehicle, and may include not only a mobile object, such as other vehicles, pedestrians, cyclists, etc., but also include an immobile object, such as a tree, a street light, and the like.

Hereinafter, the operating principles and embodiments of the present invention will be described with reference to the accompanying drawings.

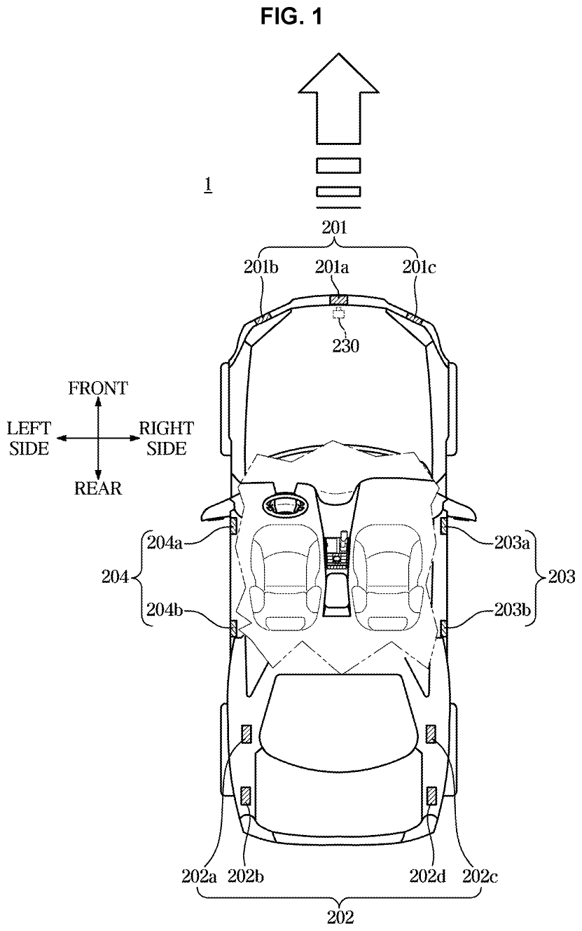

FIG. 1 illustrates a vehicle provided with a plurality of detection sensors and a lane line detector according to an exemplary embodiment of the present invention.

For the sake of convenience in description, the direction in which the vehicle 1 advances is referred to as a forward direction, and leftward and rightward directions are distinguished on the basis of the forward, in which when the forward direction refers to a direction of 12 o'clock, a direction of 3 o'clock and surrounding thereof is defined as the rightward direction, and a direction of 9 o'clock and surrounding thereof is defined as the leftward direction thereof. A direction opposite to the forward is a rearward thereof. Furthermore, a surface located in the forward direction is a front surface, a surface located in the rearward direction is a rear surface, surfaces located on the sides are referred to as side surfaces. Among the side surfaces, a side surface located in the leftward direction is defined as a left side surface, and a side surface located in the rightward direction is defined as a right side surface.

Referring to FIG. 1, a vehicle 1 is provided with a plurality of detection sensors 200 that detect an obstacle located in a surrounding area of the vehicle 1 and acquire at least one of position information and travelling velocity information related to the detected obstacle.

The plurality of detection sensors 200 according to the exemplary embodiment may acquire at least one of position information or velocity information related to an obstacle located in a surrounding area of the vehicle 1 with respect to the vehicle 1. That is, the detection sensor 200 may acquire coordinate information that changes as the obstacle moves in real time, and detect the distance between the vehicle 1 and the obstacle.

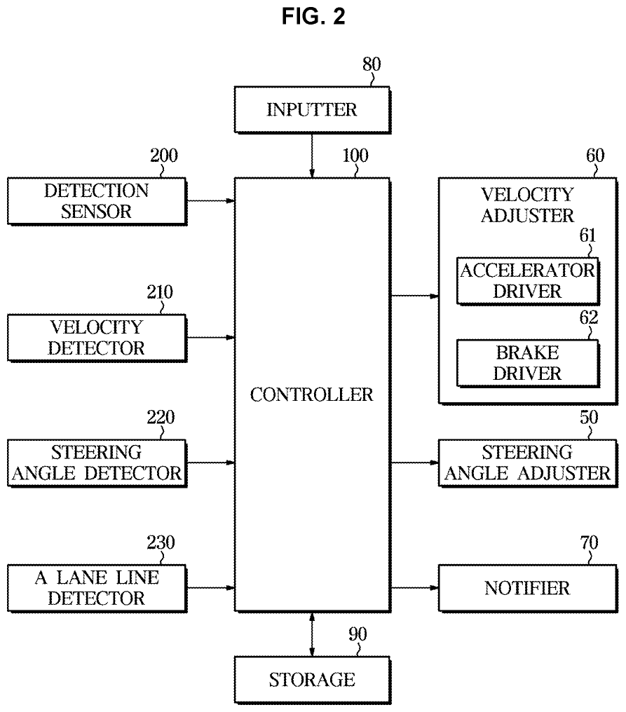

As will be described below, the controller (100 in FIG. 2) may determine the relative distance and the relative velocity between the vehicle 1 and the obstacle using the position information and the velocity information related to the obstacle acquired by the detection sensor 200, and may determine a time to collision (TCT) between the vehicle 1 and the obstacle on the basis of the determined the relative distance and the relative velocity.

Referring to FIG. 1, the detection sensor 200 may be mounted at an appropriate position to recognize an object (for example, another vehicle) located at the front, at the side, or at the front and side of the vehicle. According to the exemplary embodiment of the present invention, the detector sensor 200 may be mounted on the front portion, the left portion, and the right portion of the vehicle to recognize an object located at the front, an object located between the left side and the front of the vehicle (hereinafter, referred to as a left and front side), and an object between the right side and the front of the vehicle (hereinafter, referred to as a right and front side).

For example, a first detection sensor 201a may be mounted on a portion of a radiator grille, for example, inside the radiator grill, and may be mounted at any position of the vehicle 1 as long as it can detect a vehicle located in front of the vehicle 1. The exemplary embodiment of the present invention will be described on a case in which the first detection sensor 201a is provided at the center portion of the front surface of the vehicle 1 as an example. Furthermore, a second detection sensor 201b may be provided on the left side of the front surface of the vehicle 1, and a third detection sensor 201c may be provided on the right side of the front surface of the vehicle 1.

The detector sensor 200 may include a rear and side detection sensor 202 that detects a pedestrian or another vehicle located at the rear, at the sides, or between the rear and the sides of the vehicle, or approaching the vehicle 1 from the rear area, the side area, or the area between the rear and the sides (hereinafter, referred to as a rear and side) of the vehicle 1. The rear and side detection sensor 202 may be mounted at an appropriate position to recognize an object located at the sides, the rear, or the rear and side, for example, another vehicle, as shown in FIG. 1.

According to an exemplary embodiment of the present invention, the rear and side sensor 202 may be mounted on the left portion and the right portion of the vehicle 1 to recognize an object located between the left side and the rear (hereinafter, referred to as a left and rear side) of the vehicle 1, and an obstacle between the right side and the rear (hereinafter, referred to as a right and rear side) of the vehicle 1. For example, a first rear and side sensor 202a or a second rear and side sensor 202b is provided on the left side surface of the vehicle 1, and a third rear and side sensor 202c or a fourth rear and side sensor 202d may be provided on the right side surface of the vehicle 1.

The detection sensor 200 may also include a right side detection sensor 203 and a left side detection sensor 204 for detecting an obstacle approaching from the right side and the left side of the vehicle 1. The right side detection sensor 203 may include a first right side detection sensor 203a and a second right side detection sensor 203b to detect all obstacles in the right side of the vehicle 1. The left side detection sensor 204 also includes a first left side detection sensor 204a and a second left side detection sensor 204b to detect all obstacles in the left side of the vehicle 1.

The detection sensor 200 may be implemented using various devices, such as a radar using millimeter waves or microwaves, a light detection and ranging (LIDAR) using pulsed laser, a vision using visible ray, an infrared sensor using infrared ray, or an ultrasonic sensor using ultrasonic waves. The detection sensor 200 may be implemented using only one of such devices, or may be implemented by a combination of the devices. When a plurality of detection sensors 200 are provided in the vehicle 1, each detection sensor 200 may be implemented using the same device, or may be implemented using a different device. Furthermore, the detection sensor 200 may be implemented using in a variety of combinations of the devices which may be considered by the designer.

Furthermore, a lane line detector 230 configured for detecting a lane line in a surrounding area of the vehicle 1 may be provided at a position in which the plurality of detection sensors 200 are provided. For example, the lane line detector 230 may be provided at an area in which the first detection sensor 200a is located to detect a lane line of a lane on which the vehicle 1 is travelling.

That is, the lane line detector 230 may be implemented as an image sensor, such as a camera, mounted on the front of the vehicle 1, and photograph the surrounding environment in a direction (forward) in which the vehicle 1 advances during travelling. The image acquired from the lane line detector 230 includes information related to the extent to which the vehicle 1 is distant away from the lane line, information related to the extent to which the lane line or road is bent, and information related to the extent to which the progress direction of the vehicle 1 departs from the lane line.

Referring to FIG. 2, the vehicle 1 according to the exemplary embodiment may include a velocity adjuster 60 for adjusting a travelling velocity of the vehicle 1 driven by a driver, a steering angle adjuster 50 for adjusting a steering angle of the vehicle 1, a velocity detector 210 for detecting a travelling velocity of the vehicle 1, a steering angle detector 220 for detecting a rotation angle of a steering wheel, a lane line detector 230 for detecting a shape of a lane or road on which the vehicle 1 is travelling, a storage 90 for storing data related to the control of the vehicle 1, a controller 100 for controlling the respective components of the vehicle 1 and controlling the traveling velocity and steering angle of the vehicle 1, a notifier 70 for transmitting information related to the operation and travelling of the vehicle 1 to the driver, and an inputter 80 for receiving a command related to the control of the vehicle 1.

The velocity adjuster 60 may adjust the velocity of the vehicle 1 driven by the driver. The velocity adjuster 60 may include an accelerator driver 61 and a brake driver 62.

The accelerator driver 61 receives a control signal from the controller 100 to drive an accelerator to increase the velocity of the vehicle 1, and the brake driver 62 receives a control signal from the controller 100 to drive a brake to decrease the velocity of the vehicle 1.

The velocity adjuster 60 may adjust the traveling velocity of the vehicle 1 under the control of the controller 100. When the risk of collision between the vehicle 1 and another object is high, the velocity adjuster 60 may reduce the traveling velocity of the vehicle 1.

The steering angle adjuster 50 may adjust the steering angle of the vehicle 1 driven by the driver. In detail, the steering angle adjuster 50 may adjust the steering angle of the vehicle 1 by adjusting the rotation angle of the steering wheel of the vehicle 1 under the control of the controller 100. The steering angle adjuster t 50 may change the steering angle of the vehicle 1 when the risk of collision between the vehicle 1 and another obstacle is high.

The velocity detector 210 may detect the travelling velocity of the vehicle 1 driven by the driver under the control of the controller 100. That is, the driving velocity may be detected using the velocity at which the wheels of the vehicle 1 rotates, and the like. The travelling velocity may be represented in kilometers per hour [kph], that is, a distance (km) traveled per unit time (h).

The steering angle detector 220 may detect a steering angle which is a rotation angle of the steering wheel during travelling of the vehicle 1. That is, when the vehicle 1 avoids a neighboring obstacle through steering during travelling, the controller 100 may control the steering of the vehicle 1 on the basis of the steering angle detected by the steering angle detector 220.

The lane line detector 230 is implemented as a video sensor, such as a camera, mounted on the front of the vehicle 1, and detects a lane line of a lane on which the vehicle 1 is travelling, and transmits a result of the detection to the controller 100. The image acquired from the lane line detector 230 includes information related to the extent to which the vehicle 1 is distant away from the lane line, information related to the extent to which the lane line or road is bent, and information related to the extent to which the progress direction of the vehicle 1 departs from the lane line.

The lane line detector 230 may acquire information related to the distance to the lane line, the curvature of the road being travelled on, and the lane departure angle, and transmit the information to the controller 100.

The storage 90 may store various types of data related to the control of the vehicle 1. In detail, the storage 90 may store information related to a traveling velocity, a traveling distance, and a traveling time of the vehicle 1. Furthermore, the storage 90 may store position information and velocity information related to an obstacle detected by the detector sensor 200, and may store information related to coordinate information related to a moving obstacle that changes in real time, a relative distance between the vehicle 1 and the object, and a relative velocity between the vehicle 1 and the object.

Furthermore, the storage 90 may store a predetermined area in the travelling lane of the vehicle 1. Furthermore, the storage 90 may store data related to equations and control algorithms for controlling the vehicle 1 according to the exemplary embodiment of the present invention, and the controller 100 may transmit a control signal for controlling the vehicle 1 according to the equations and the control algorithms.

Furthermore, as will be described below, the storage 90 may store a steering avoidance route which is set for the vehicle to avoid a collision with a target vehicle ob1 located in a next lane of the vehicle 1 and return the traveling lane, and store information related to a rotation angle of the steering wheel acquired by the steering angle detector 220.

The storage 90 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the storage 90 is not limited thereto. The storage 90 may be a memory implemented as a chip separated from the processor, which will be described below in connection with the controller 100, or may be implemented as a single chip integrated with the processor.

The notifier 70 may transmit a warning signal according to a control signal of the controller 100. In detail, the notifier 70 may include a display, a speaker, and a vibrator r provided in the vehicle 1, and may output a display, sound, and vibration to warn the driver of a danger of collision according to a control signal of the controller 100.

The controller 100 may include at least one memory in which a program for performing an operation described below is stored and at least one processor for executing the stored program. When the memory and the processor are provided in plural, the plurality of memories and processors may be integrated in one chip, or may be provided in physically separated locations.

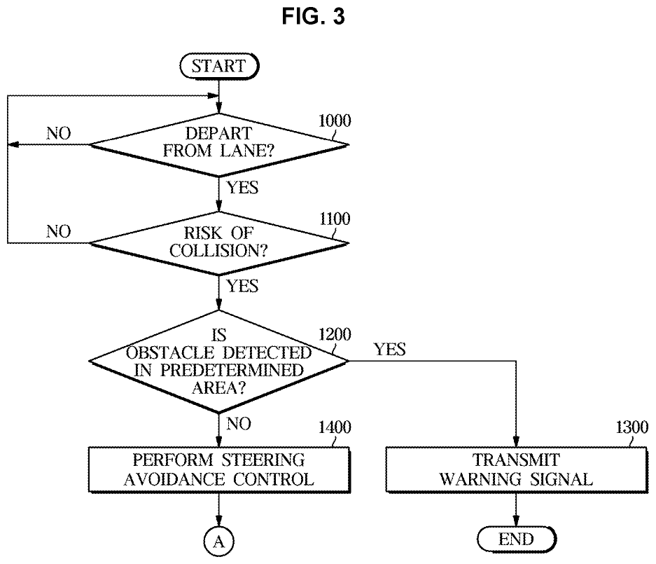

Hereinafter, a method of controlling the vehicle 1 when there is a risk of secondary collision during a steering avoidance control for avoiding a neighboring obstacle will be described with reference to FIGS. 3, 5, and 6.

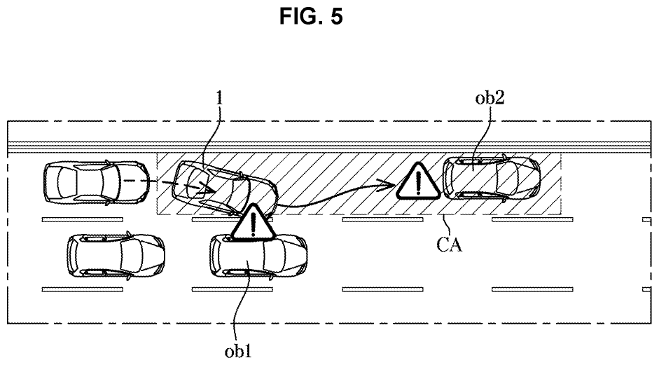

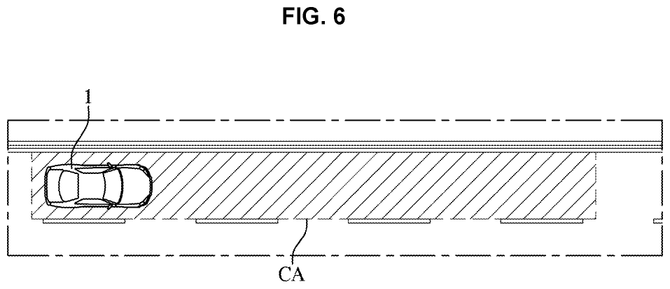

FIG. 3 is a flowchart showing a method of controlling a vehicle according to an exemplary embodiment of the present invention, FIG. 5 is a view exemplarily illustrating an avoidable area according to an exemplary embodiment of the present invention, and FIG. 6 is a view exemplarily illustrating a case in which a secondary collision of a vehicle is expected to occur according to an exemplary embodiment of the present invention.

Referring to FIG. 3, the lane line detector 230 may detect a lane line of a travelling lane in which the vehicle 1 is travelling, and the controller 100 may determine whether the vehicle 1 departs from the travelling lane on the basis of the detected lane line (1000). The controller 100 may determine a risk of collision between a neighboring obstacle ob1 detected from the detection sensor 200 and the vehicle 1 (1100) if a departure from the travelling lane of the vehicle 1 is expected to occur (Yes in operation 1000), and may determine whether to perform a steering avoidance control of the vehicle if it is determined that there is a risk of the collision (Yes in operation 1100). In the instant case, the neighboring obstacle ob1 in a surrounding of the vehicle 1 may refer to all types of obstacles which may bring the vehicle 1 into a collision at a time of departure of the vehicle 1 from the travelling lane. The controller 100 may determine whether an obstacle is detected in a surrounding of the vehicle 1 including a predetermined area CA in the travelling lane of the vehicle 1 (1200), and if an obstacle is not detected in the predetermined area CA, control the vehicle 1 to perform a steering avoidance control for the vehicle 1 to avoid the collision (1400). The controller 100 may control the vehicle 1 to perform the steering avoidance control by controlling the velocity adjustor 60 and the steering angle adjustor 50.

In the instant case, the controller 100 determines a lateral movement distance for returning the vehicle 1 to the travelling lane, on which the vehicle 1 has been travelled, on the basis of width information related to the lane lines of the travelling lane and the vehicle 1, and may control the vehicle 1 to perform the steering avoidance control on the basis of the determined lateral movement distance.

On the other hand, when an obstacle ob2 is detected in the predetermined area CA, the controller 100 may control the vehicle 1 not to perform the steering avoidance control. In the instant case, the controller 100 may generate a control signal for transmitting a warning signal (1300).

The predetermined area may be determined as an area in which a risk of collision between the vehicle 1 and the obstacle ob2 is high when the obstacle ob2 exists within the area. For example, the predetermined area may include a side area, a front area, and a rear area of the vehicle 1 within the travelling lane of the vehicle 1.

As described above with reference to FIGS. 3, 5, and 6, even when the vehicle 1 departs from the lane and there is a risk of collision with the neighboring vehicle ob1, if the risk of secondary collision with the obstacle ob2 in the predetermined area CA is high, the vehicle 1 allows a warning signal to be sent without performing the steering control, so that the secondary collision is prevented and the degree of accident risk is minimized.

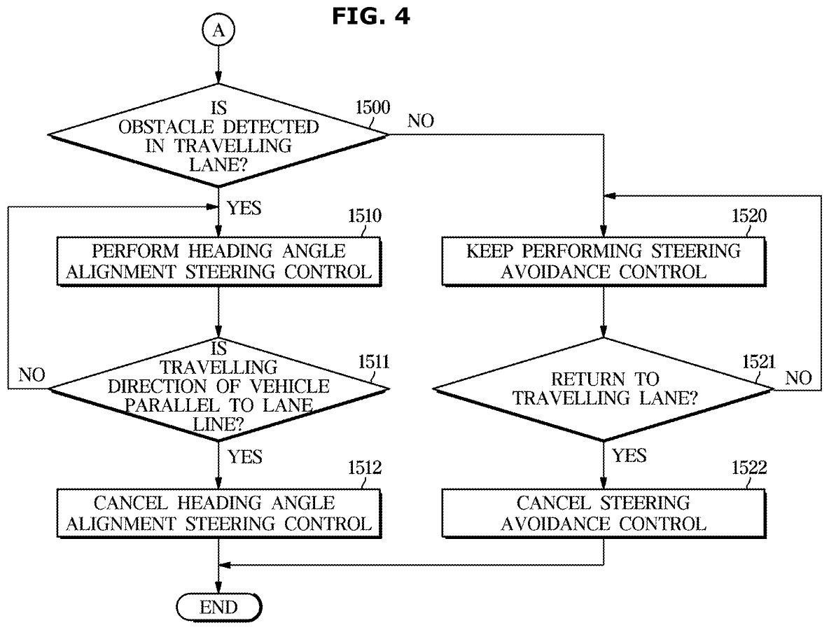

Hereinafter, a method of controlling the vehicle 1 when there is a risk of secondary collision during the steering avoidance control of the vehicle 1 will be described with reference to FIG. 4 and FIGS. 7 to 8.

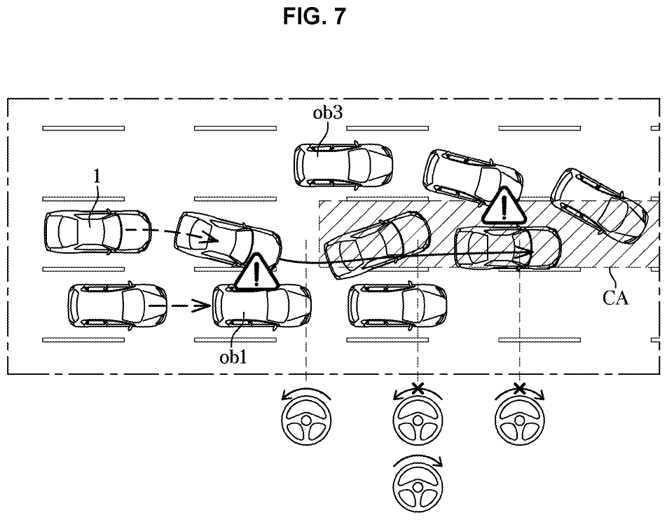

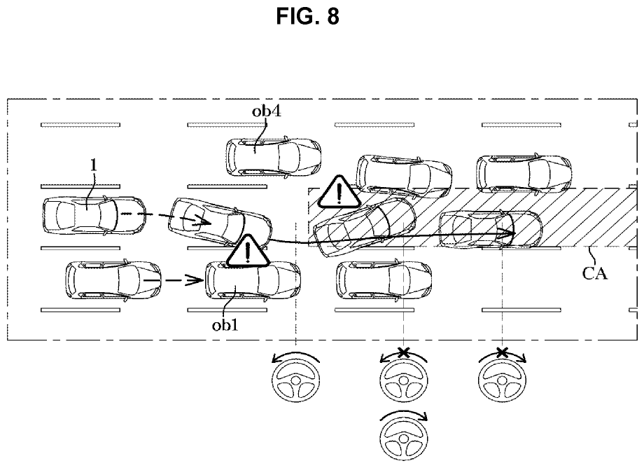

FIG. 4 is a flowchart showing a method of controlling a vehicle according to an exemplary embodiment of the present invention, and FIG. 7 and FIG. 8 are views illustrating a case in which an obstacle is detected in an avoidable area during a steering control of a vehicle according to an exemplary embodiment of the present invention.

The controller 100 may cancel the steering avoidance control if obstacles ob3 and ob4 are detected in the predetermined area CA in the traveling lane of the vehicle 1 during the steering avoidance control of the vehicle 1 (Yes in operation 1500), and perform a heading angle alignment steering control such that the traveling direction of the vehicle 1 is parallel to the lane lines of the travelling lane of the vehicle 1 (1510). In the instant case, as described above, the predetermined area CA may include a side area and a front area of the vehicle 1 within the travelling lane of the vehicle 1.

Furthermore, the controller 100 may determine the predetermined area CA on the basis of the velocity of the vehicle 1 or the like. In detail, the controller 100 may determine the predetermined area CA to have a larger area as the vehicle 1 has a higher velocity. In the instant case, the predetermined area CA may refer to an avoidable area in which the vehicle 1 may avoid the neighboring obstacle ob1 by performing the steering control.

That is, when obstacles ob3 and ob4 are detected in the avoidable area CA during the steering avoidance control of the vehicle 1, there is a risk of collision between the vehicle 1 and the obstacles ob3 and ob4 located in the avoidable area CA.

Accordingly, if obstacles ob3 and ob4 are detected in the avoidable area CA during the steering avoidance control of the vehicle 1, the controller 100 cancels the steering avoidance control and performs a heading angle alignment steering control for aligning the heading angle of the vehicle 1 to prevent the secondary collision. During a steering control in the opposite direction, the controller 100 may determine whether the travelling direction of the vehicle 1 becomes parallel to the detected lane lines (1511). The controller 100 may cancel the heading angle alignment steering control when the travelling direction of the vehicle 1 is parallel to the detected lane lines during the steering control in the opposite direction (1512).

That is, when an obstacle is detected in the avoidable area CA during the steering avoidance control of the vehicle 1, the controller 100 cancels the steering avoidance control for avoiding the collision and performs the heading angle alignment steering control such that the heading angle of the vehicle 1 is kept in line with the lane line direction, so that secondary collision between the vehicle 1 and the obstacles ob3 and ob4 in the avoidable area CA may be prevented.

FIG. 7 is a view exemplarily illustrating a case in which another obstacle ob3 is detected in the avoidable area CA during a steering avoidance control of the vehicle 1. In the instant case, the predetermined area CA refers to a front area of the vehicle 1 within the travelling lane of the vehicle 1.

To prevent a secondary collision between the vehicle 1 and the front vehicle ob3 in front of the vehicle 1, the controller 100 may cancel the steering avoidance control for avoiding collision and perform a steering control in a direction opposite to the steering direction of the steering avoidance control. Furthermore, when the travelling direction of the vehicle 1 becomes parallel to the detected lane line during the steering control in the opposite direction, the controller 100 may cancel the steering control in the opposite direction to prevent departure from the lane and collision with the vehicle ob1 on the next lane.

FIG. 8 is a diagram illustrating a situation in which another vehicle ob4 is detected in the predetermined area CA during steering avoidance control of the vehicle 1. In the instant case, the predetermined area CA is a side area of the vehicle 1 within the traveling lane of the vehicle 1.

To prevent a secondary collision between the vehicle 1 and the side vehicle ob4 at the side area of the vehicle 1, the controller 100 may cancel the steering avoidance control for avoiding collision and perform a steering control in a direction opposite to the steering direction of the steering avoidance control. Furthermore, when the travelling direction of the vehicle 1 becomes parallel to the detected lane lines during the steering control in the opposite direction, the controller 100 may cancel the steering control in the opposite direction to prevent departure from the lane and collision with the vehicle ob1 on the next lane.

Referring again to FIG. 4, if an obstacle is not detected in the predetermined area CA within the travelling lane of the vehicle 1 during the steering avoidance control of the vehicle 1 (NO in operation 1500), the controller 100 may keep performing the steering avoidance control (1520). Thereafter, the controller 100 may determine whether the vehicle 1 completely returns to the travelling lane (1521), and if the vehicle 1 completely returns to the travelling lane, the controller 100 may cancel the steering avoidance control (1522).

That is, the controller 100 may control the vehicle 1 to perform the steering avoidance control according to a determined steering avoidance route until the vehicle 1 returns to the lane if there is no risk of a secondary collision of the vehicle 1.

To summarize, if an obstacle is not detected in the predetermined area CA before a steering avoidance control of the vehicle 1 is performed, the controller 100 may allow the vehicle 1 to perform the steering avoidance control and provide only a collision risk warning to the driver, and if an obstacle is detected in the predetermined area CA before the steering avoidance control of the vehicle 1, the controller 100 may allow the vehicle 1 not to perform the steering avoidance control.

when an obstacle is not detected in the predetermined area CA and the vehicle 1 performs steering avoidance control, the controller 100 determines whether an obstacle expected to cause a secondary collision is detected in the predetermined area CA during the steering avoidance control, and if the obstacle expected to cause a secondary collision is not detected, the controller 100 allows the vehicle 1 to keep performing the steering avoidance control for returning the vehicle 1 to the lane traveled on.

If an obstacle expected to cause a secondary collision is detected in the predetermined area CA during the steering avoidance control, the controller 100 cancels the steering avoidance control for returning the vehicle 1 to the lane travelled on, and perform the heading angle alignment steering control such that the travelling direction of the vehicle 1 is parallel to the lane line of the lane travelled on.

For example, under the assumption that the vehicle 1 is travelling on the third lane in a three-lane road which is the furthest from the dividing line, and a bicycle lane exists next to the third lane, when the vehicle 1 departs from the third lane and crosses the second lane, the controller 100 determines whether an obstacle is detected in a predetermined area in the third lane travelled on, and if an obstacle is not detected in the predetermined area, allows the vehicle 1 to perform a steering avoidance control for retuning the vehicle 1 to the third lane. At the instant time, if a cyclist running on the bicycle lane enters the third lane with a lateral movement and enters the predetermined area, the controller 100 may cancel the steering avoidance control of the vehicle 1 and perform a heading angle alignment steering control such that the travelling direction of the vehicle 1 is parallel to the lane lines of the third lane. In addition to performing the heading angle alignment steering control, a collision risk warning may be provided to the driver to prevent a secondary collision.

Furthermore, if the cyclist running on the bicycle lane has a lateral movement but does not enter the third lane, it is determined that an obstacle is not detected in the predetermined area, and thus the controller 100 keeps performing the steering avoidance of the vehicle 1 such that the vehicle 1 returns to the third lane.

According to the vehicle according to the exemplary embodiment of the present invention and the method of controlling the same, when there is a need to perform a steering control because the vehicle 1 is in danger of collision with a side area obstacle due to the vehicle 1 departing from the lane, different types of steering control are performed depending on the existence of an avoidable area, so that a secondary collision with another obstacle is prevented.

Meanwhile, the disclosed exemplary embodiments may be embodied in a form of a recording medium storing instructions executable by a computer. The instructions may be stored in a form of program code, and when executed by a processor, may generate a program module to perform the operations of the included exemplary embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, when a vehicle needs to perform a steering control due to a risk of collision with a side obstacle at a time of a lane departure, the vehicle performs different types of steering control depending on the existence of an avoidable area so that a secondary obstacle with another obstacle may be avoided.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
a plurality of detection sensors configured to detect a neighboring obstacle in a surrounding of a vehicle;
a lane line detector configured to detect a lane line of a travelling lane on which the vehicle is travelling; and
a controller configured to determine when the vehicle departs from the travelling lane on a basis of the detected lane line, to determine when an obstacle is detected in a predetermined area in the travelling lane, to determine a risk of collision between the vehicle and a neighboring obstacle, and upon determining that the vehicle is predicted to depart from the travelling lane and the vehicle is predicted to collide with the neighboring obstacle, to determine when to perform a steering avoidance control for avoiding the collision on a basis of a result of detecting the obstacle in the predetermined area.

2. The vehicle of claim 1, wherein the controller is configured to control the vehicle to perform the steering avoidance control when an obstacle is not detected in the predetermined area.

3. The vehicle of claim 2, wherein the controller is configured to cancel the steering avoidance control and is configured to perform a heading angle alignment steering control such that a travelling direction of the vehicle is in parallel to lane lines of the travelling lane when the obstacle is detected in the predetermined area during the steering avoidance control of the vehicle.

4. The vehicle of claim 1, wherein the predetermined area includes a side area, a front area, and a rear area of the vehicle in the travelling lane.

5. The vehicle of claim 1, wherein the controller is configured to control the vehicle not to perform the steering avoidance control when the obstacle is detected in the predetermined area.

6. The vehicle of claim 1, wherein the controller is configured to generate a control signal for sending a warning signal when the vehicle is predicted to depart from the travelling lane and the vehicle is predicted to collide with the neighboring obstacle.

7. The vehicle of claim 1, wherein the controller is configured to determine the predetermined area on a basis of a velocity of the vehicle.

8. The vehicle of claim 2, wherein the controller is configured to determine a lateral movement distance for avoiding the collision of the vehicle on a basis of width information related to the lane line of the travelling lane and the vehicle, and is configured to control the vehicle to perform the steering avoidance control on a basis of the determined lateral movement distance.

9. A method of controlling a vehicle, the method including:
detecting a lane line of a travelling lane on which the vehicle is travelling;
determining, by a controller, when the vehicle departs from the travelling lane on a basis of the detected lane line;
determining, by the controller, when an obstacle is detected in a predetermined area in the travelling lane;
determining, by the controller, a risk of collision between the vehicle and a neighboring obstacle in a surrounding of the vehicle; and
determining, by the controller, when to perform a steering avoidance control for avoiding the collision on a basis of a result of detecting the obstacle in the predetermined area upon determining that the vehicle is expected to depart from the travelling lane and the vehicle is predicted to collide with the neighboring obstacle.

10. The method of claim 9, wherein the determining of when to perform the steering avoidance control for avoiding the collision includes: controlling the vehicle to perform the steering avoidance control upon determining that the obstacle is not detected in the predetermined area.

11. The method of claim 10, further including cancelling, by the controller, the steering avoidance control and performing a heading angle alignment steering control such that a travelling direction of the vehicle is in parallel to lane lines of the travelling lane when the obstacle is detected in the predetermined area during the steering avoidance control of the vehicle.

12. The method of claim 9, wherein the predetermined area includes a side area, a front area, and a rear area of the vehicle in the travelling lane.

13. The method of claim 9, wherein the determining of when to perform the steering avoidance control for avoiding the collision includes controlling the vehicle not to perform the steering avoidance control upon determining that the obstacle is detected in the predetermined area.

14. The method of claim 9, further including generating a control signal for sending a warning signal upon determining that the vehicle is predicted to depart from the travelling lane and the vehicle is predicted to collide with the neighboring obstacle.

15. The method of claim 9, further including determining the predetermined area on a basis of a velocity of the vehicle.

16. The method of claim 10, wherein the controlling of the vehicle to perform the steering avoidance control for avoiding the collision includes:
determining a lateral movement distance for returning to the travelling lane of the vehicle on a basis of width information related to lane lines of the travelling lane and the vehicle; and
controlling the vehicle to perform the steering avoidance control on a basis of the determined lateral movement distance.
